(19) United States
(12) Patent Application Publication
(10) Pub. No.: US 2025/0024328 A1
(43) Pub. Date: Jan. 16, 2025

(54) TERMINAL DEVICE, WIRELESS COMMUNICATION SYSTEM, AND METHOD FOR PROCESSING TERMINAL DEVICE

(71) Applicant: Sony Group Corporation, Tokyo (JP)

(72) Inventor: Takuya IWAI, Saitama (JP)

(73) Assignee: Sony Group Corporation, Tokyo (JP)

(21) Appl. No.: 18/709,594

(22) PCT Filed: Sep. 29, 2022
(86) PCT No.: PCT/JP2022/036542

§ 371 Date: May 13, 2024

(30) Foreign Application Priority Data
Nov. 26, 2021 (JP) 2021-191727

(51) Int. Cl. H04W 28/08; H04L 5/00; H04W 28/10; H04W 28/18

(52) U.S. Cl. CPC H04W 28/0983; H04L 5/0048; H04W 28/10; H04W 28/18

(57) ABSTRACT

In a wireless communication system, the impact on communication quality at other terminals when data transmission and reception is newly started is reduced.

The wireless communication system includes: a first terminal device that is performing wireless communication; a second terminal device that attempts to perform data transmission and reception through wireless communication; and a throughput management device that manages throughputs of the first terminal device and the second terminal device. The second terminal device transmits to the throughput management device a throughput calculation request message requesting throughput calculation for data transmission and reception through wireless communication. In response to receiving a throughput calculation response message, which is a response to the throughput calculation request message, the second terminal device starts data transmission and reception according to a recommended throughput included in the throughput calculation response message.

### TECHNICAL FIELD

The present technology relates to a wireless communication system. Specifically, the present technology relates to a wireless communication system in which a plurality of terminal devices perform transmission and reception, a terminal device, and a method for processing the terminal device.

### BACKGROUND ART

The maximum throughput for a user terminal to transmit and receive data within a wireless cell is affected by data transmission and reception of other user terminals. However, the user terminal cannot estimate its own maximum throughput because it cannot know in advance how much data other user terminals in the same wireless cell are transmitting and receiving. Accordingly, the user terminal searches for the optimal value by gradually increasing the throughput when transmitting and receiving data by slow start. However, taking a long time for the optimal value results in an increased period of poor image quality, and as a result, the quality of user experience may be impaired. In response to this, for example, a communication system has been proposed in which packet communication is controlled according to the rate of change in cell congestion caused by the number of wireless terminals (see, for example, PTL 1).

### CITATION LIST

### Patent Literature

[PTL 1]
JP 2017-152760A

### Summary

### Technical Problem

In the above-described conventional technology, the cell load is calculated by focusing on the number of wireless terminals. However, with the above-described conventional technology, it is not possible to know the amount of traffic and the timing at which traffic occurs in each user terminal, and the traffic of a specific user terminal may induce latency fluctuations in other user terminals.

The present technology has been made in view of such situations, and an object thereof is to reduce the impact on communication quality at other terminals when data transmission and reception is newly started.

### Solution to Problem

The present technology has been made to solve the above-described problem, and a first aspect thereof is a terminal device and a method for processing the terminal device, including: transmitting a throughput calculation request message requesting throughput calculation for data transmission and reception through wireless communication; and in response to receiving a throughput calculation response message, which is a response to the throughput calculation request message, starting the data transmission and reception according to a recommended throughput included in the throughput calculation response message. This provides an effect of acquiring in advance a recommended throughput that does not affect communication quality and starting data transmission and reception.

In this first aspect, the throughput calculation request message may include a throughput request value of the data transmission and reception, and may be a message requesting to reduce a throughput to another terminal device that is performing wireless communication to achieve the throughput request value. This provides an effect of newly starting data transmission and reception in a new terminal device with a reduced throughput for another terminal device that is performing wireless communication.

In this first aspect, the throughput calculation response message may include an initial value of an amount of data subjected to the data transmission and reception and an operation parameter regarding an increase in the amount of data.

A second aspect of the present technology is a terminal device and a method for processing the terminal device, including: in response to receiving a throughput change instruction message instructing to change a throughput of wireless communication, which is being performed, to the recommended throughput, determining whether or not the throughput can be changed to the recommended throughput; and changing the throughput of wireless communication, which is being performed, according to the recommended throughput when the throughput can be changed to the recommended throughput. This provides an effect of changing its own throughput to the recommended throughput before the other terminal device newly starts transmission and reception.

In this second aspect, a throughput change response message that is a response to the throughput change instruction message may be transmitted including a result of determining whether or not the throughput can be changed to the recommended throughput.

In this second aspect, the determination as to whether or not the throughput can be changed to the recommended throughput may be based on whether or not a predetermined quality of experience is satisfied.

A third aspect of the present technology is a wireless communication system, including: a first terminal device that is performing wireless communication; a second terminal device that attempts to perform data transmission and reception through wireless communication; and a throughput management device that manages throughputs of the first terminal device and the second terminal device, wherein the second terminal device transmits a throughput calculation request message requesting throughput calculation for data transmission and reception through wireless communication, the throughput management device calculates a recommended throughput for the second terminal device in response to receiving the throughput calculation request message, and transmits a throughput change instruction message instructing to change a throughput of wireless communication, which is being performed at the first terminal device, to the recommended throughput, the first terminal device determines whether or not the throughput can be changed to the recommended throughput in response to receiving the throughput change instruction message, and when the throughput can be changed to the recommended throughput, changes the throughput of wireless communication being performed according to the recommended throughput, the throughput management device transmits a throughput calculation response message including the recommended throughput, and the second terminal device starts the data transmission and reception according to the recommended throughput included in the throughput calculation response message in response to receiving the throughput calculation response message. This provides an effect of calculating a recommended throughput in the throughput management device and preventing an increase in latency in the first terminal device even when the second terminal device starts new transmission and reception.

In this third aspect, the throughput management device may transmit the throughput calculation response message after receiving from the first terminal device a throughput change response message that is a response to the throughput change instruction message.

In this third aspect, the throughput management device may transmit the throughput calculation response message after a predetermined time has elapsed since the throughput change instruction message was transmitted. In this case, there is no need to wait for a throughput change response message.

### BRIEF DESCRIPTION OF DRAWINGS

FIG. 1 is a diagram illustrating an example of an overall configuration of a wireless communication system according to an embodiment of the present technology.

FIG. 2 is a diagram illustrating a configuration example of a terminal 100 according to an embodiment of the present technology.

FIG. 3 is a diagram illustrating a configuration example of an application server 600 according to an embodiment of the present technology.

FIG. 4 is a diagram illustrating a configuration example of a throughput management device 400 according to an embodiment of the present technology.

FIG. 5 illustrates an example of field configurations of a throughput calculation request message and a throughput calculation response message according to a first embodiment of the present technology.

FIG. 6 illustrates an example of field configurations of a throughput change instruction message and a throughput change response message according to the first embodiment of the present technology.

FIG. 7 is a sequence diagram illustrating an example of a processing flow of a wireless communication system according to the first embodiment of the present technology.

FIG. 8 is a flowchart illustrating an example of a processing procedure of a terminal 102 according to the first embodiment of the present technology.

FIG. 9 is a flowchart illustrating an example of a processing procedure of a terminal 101 according to the first embodiment of the present technology.

FIG. 10 is a flowchart illustrating an example of a processing procedure of a throughput management device 400 according to the first embodiment of the present technology.

FIG. 11 illustrates an example of a field configuration of a throughput calculation request message according to a second embodiment of the present technology.

FIG. 12 is a sequence diagram illustrating an example of a processing flow of a wireless communication system according to the second embodiment of the present technology.

FIG. 13 is a flowchart illustrating an example of a processing procedure of a terminal 101 according to the second embodiment of the present technology.

FIG. 14 is a flowchart illustrating an example of a processing procedure of a throughput management device 400 according to the second embodiment of the present technology.

FIG. 15 illustrates an example of a field configuration of a throughput calculation request message according to a third embodiment of the present technology.

FIG. 16 illustrates an example of a field configuration of a throughput conversion table 716 according to the third embodiment of the present technology.

### DESCRIPTION OF EMBODIMENTS

Modes for carrying out the present technique (hereinafter also referred to as “embodiments”) will be described below. The description will be given in the following order.
1. First Embodiment (Example of Waiting for Throughput Change Response)
2. Second Embodiment (Example of not Waiting for Throughput Change Response)
3. Third Embodiment (Example of Considering Quality of Experience)

### 1. First Embodiment

### [Overall Configuration of Wireless Communication System]

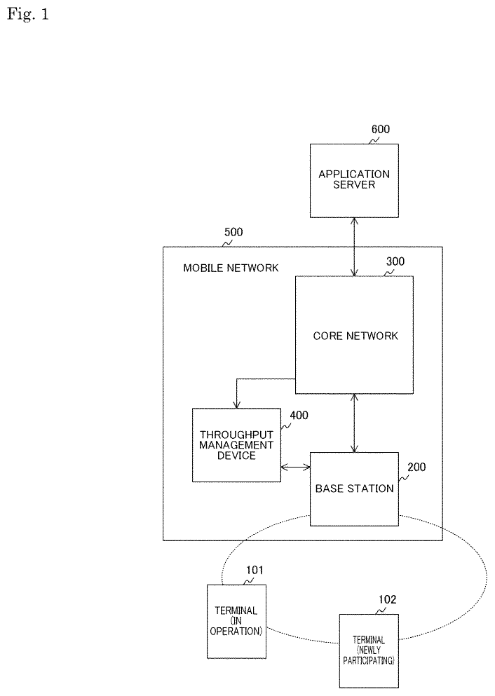

FIG. 1 is a diagram illustrating an example of an overall configuration of a wireless communication system according to an embodiment of the present technology.

This wireless communication system includes terminals 101 and 102, a mobile network 500, and an application server 600. The terminals 101 and 102 are communication terminals that transmit and receive data. The terminal 101 is a communication terminal that is transmitting and receiving data first. The terminal 102 is a communication terminal that attempts to start transmitting and receiving data. Although the following description is based on the premise that the terminals 101 and 102 transmit and receive data to and from a base station 200, the partner to and from which data is transmitted and received is not limited to this. For example, they may perform side link communication with another terminal, or each terminal may be a relay terminal that performs relay communication between a base station and a terminal.

The application server 600 is a communication partner of the terminals 101 and 102, and is also a server that provides application functions to the terminals 101 and 102.

The mobile network 500 is a network that provides a communication path between the terminals 101 and 102 and the application server 600. This mobile network 500 is, for example, a 4th Generation Mobile Communication System (4G)/Long Term Evolution (LTE) network or a 5th Generation Mobile Communication System (5G) network, which is defined by 3rd Generation Partnership Project (3GPP) (registered trademark). This mobile network 500 includes the base station 200, a core network 300, and a throughput management device 400.

The base station 200 is a base station to which the terminals 101 and 102 are to connect. This base station 200 is provided as, for example, a next generation Node B (gNB) in a 5G network defined by 3GPP.

The core network 300 is a network made up of network devices such as the Access and Mobility Management Function (AMF), the Session Management Function (SMF), and the User Plane Function (UPF), which are other than gNBs in the 5G network defined by 3GPP.

The throughput management device 400 cooperates with the base station 200 and the core network 300 to transmit and receive messages for managing the throughput to and from the terminals 101 and 102. The throughput management device 400 may be included in the base station 200 or may be located between the base station 200 and the terminal 101 or 102.

Although a case is described above by way of example in which there are provided one existing terminal 101, one newly participating terminal 102, and one application server 600, this is just an example, and each may be replaced with a plurality of terminals/servers. Such an implementation may be applied to relay terminal configuration, side link communication configuration, and the like, not illustrated.

[Configuration of Terminal]

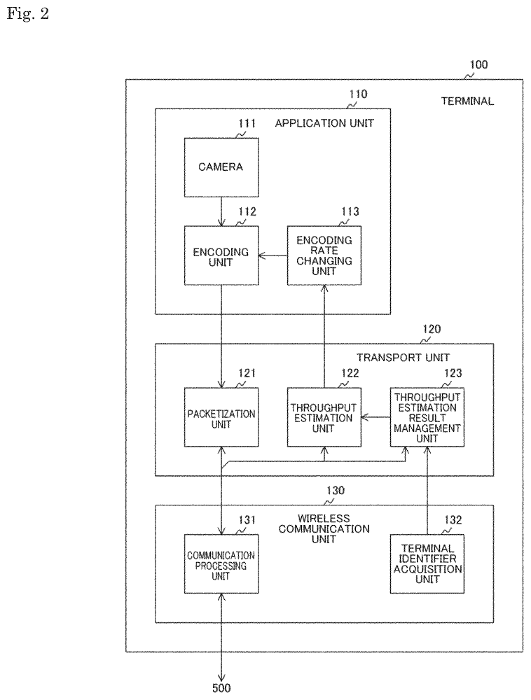

FIG. 2 is a diagram illustrating a configuration example of a terminal 100 according to an embodiment of the present technology. This terminal 100 is a generic term for the above-described terminals 101 and 102.

This terminal 100 includes an application unit 110, a transport unit 120, and a wireless communication unit 130. The application unit 110 is an application-specific logic implemented in software or hardware, and generates data to be transmitted to the application server 600. The transport unit 120 stores the data generated by the application unit 110 in the payload of an IP packet, and transfers the data to the application server 600. The wireless communication unit 130 connects to the mobile network 500 and provides an IP layer communication path to the transport unit 120.

Here, the application unit 110 is illustrated to have a configuration for a video distribution application as an example of the application-specific logic. In this case, the application unit 110 includes a camera 111, an encoding unit 112, and an encoding rate changing unit 113.

The camera 111 generates a signal related to captured image data using a Universal Serial Bus (USB) or the like as an interface.

The encoding unit 112 compresses the signal from the camera 111. This encoding unit 112 has parameters that affect the compression rate of the signal. Such parameters may include, for example, resolution, frame rate, bit rate, and QP value (quantization parameter).

The encoding rate changing unit 113 changes the parameters of the encoding unit 112 based on instructions from the transport unit 120. As an example of the technology related to this encoding rate changing unit 113, for example, codecs implemented by hardware or software such as H. 264 and H. 265 may be used.

The transport unit 120 stores data from the application unit 110 in the payload of a TCP/IP or UDP/IP packet, and transmits the resulting packet via the wireless communication unit 130 to the application server 600, which will be described later. The transport unit 120 includes a packetization unit 121, a throughput estimation unit 122, and a throughput estimation result management unit 123.

The packetization unit 121 stores data from the application unit 110 in the payload of a TCP/IP or UDP/IP packet. This packetization unit 121 may store data from the application unit 110 according to, for example, an Real-time Transport Protocol (RTP) format using UDP/IP.

The throughput estimation unit 122 is responsible for estimating the maximum throughput from the terminal 102 to the application server 600. Specifically, the terminal 102 gradually increases the amount of data to be transmitted to the application server 600 from the initial value, receives from the application server 600 information regarding the loss or latency of IP packets resulting from that transmission, and estimates the maximum throughput to the application server 600 based on a result indicated by the information.

As a means for the throughput estimation unit 122 to receive information regarding the loss and latency of IP packets, for example, a method using RTP Control Protocol (RTCP) using UDP/IP may be used. As a means for the throughput estimation unit 122 to estimate the throughput, for example, end-to-end rate estimation using TCP or Google Congestion Control (GCC) may be used.

This throughput estimation unit 122 instructs, based on the result of estimation, the encoding rate changing unit 113 to change parameters that affect the compression rate of the signal.

The throughput estimation result management unit 123 manages the result of estimation by the throughput estimation unit 122. This throughput estimation result management unit 123 performs processing of overwriting the result of estimation by the throughput estimation unit 122 with a value acquired from the throughput management device 400.

Here, the throughput estimation result management unit 123 in the terminal 102 transmits a throughput calculation request message to the throughput management device 400. The throughput estimation result management unit 123 then receives a throughput calculation response message from the throughput management device 400.

On the other hand, the throughput estimation result management unit 123 in the terminal 101 receives a throughput change instruction message from the throughput management device 400. This throughput change instruction message includes information regarding a recommended throughput (e.g., Mbps), as will be described later, and determines whether or not to change the throughput for the terminal 101 to the recommended throughput. Here, if the throughput estimation result management unit 123 determines to change the throughput to the recommended throughput, the throughput estimation result management unit 123 overwrites the result of estimation by the throughput estimation unit 122 with the recommended throughput. On the other hand, if the throughput estimation result management unit 123 determines not to change the throughput, the throughput estimation result management unit 123 does not overwrite. In either case, the throughput estimation result management unit 123 transmits a throughput change response message to the throughput management device 400. This throughput change response message also includes information as to whether or not the throughput has been changed to the recommended throughput.

The wireless communication unit 130 connects to the mobile network 500 and enables the transport unit 120 to transmit and receive IP packets. The wireless communication unit 130 includes a communication processing unit 131 and a terminal identifier acquisition unit 132.

The communication processing unit 131 connects to the mobile network 500 and performs communication at the IP layer. The terminal identifier acquisition unit 132 acquires the terminal identifier of the corresponding terminal 100 and supplies the terminal identifier to the throughput estimation result management unit 123.

### [Configuration of Application Server]

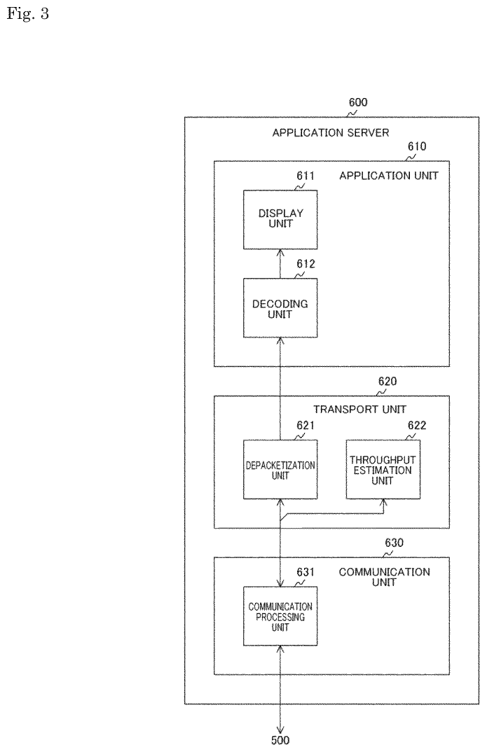

FIG. 3 is a diagram illustrating a configuration example of the application server 600 according to an embodiment of the present technology.

The application server 600 includes an application unit 610, a transport unit 620, and a communication unit 630.

The application unit 610 receives data generated by the application units 110 of the terminals 101 and 102 via the transport unit 620, and executes the application-specific logic. This application unit 610 uses the data stored in the payload of an IP packet received by the transport unit 620 to execute the application-specific logic implemented in software or hardware. Assuming a video distribution application as described above, this application unit 610 includes a display unit 611 and a decoding unit 612.

The decoding unit 612 decodes the signal compressed in the terminal 100. As in the encoding unit 112, this decoding unit 612 may use, for example, codecs implemented by hardware or software such as H. 264 and H. 265.

The display unit 611 displays the signal decoded by the decoding unit 612. This display unit 611 may be, for example, an application implemented using software such as a web browser, or an external monitor implemented using hardware connected to the application server 600 via HDMI (registered trademark) or the like.

The transport unit 620 communicates with the transport units 120 of the terminals 101 and 102, and extracts data from the IP packet received by the communication unit 630 and passes the data to the application unit 610. This transport unit 620 includes a depacketization unit 621 and a throughput estimation unit 622.

The depacketization unit 621 extracts data from the payload of the RTP/IP packet received from the communication unit 630 and passes the data to the application unit 610.

The throughput estimation unit 622 acquires information regarding the loss and latency of IP packets while transmitting and receiving the IP packets to and from the terminal 100.

The communication unit 630 connects to the mobile network 500 through a wired connection such as Ethernet and provides an IP layer communication path to the transport unit 620. This communication unit 630 includes a communication processing unit 631 that performs communication processing.

### [Configuration of Throughput Management Device]

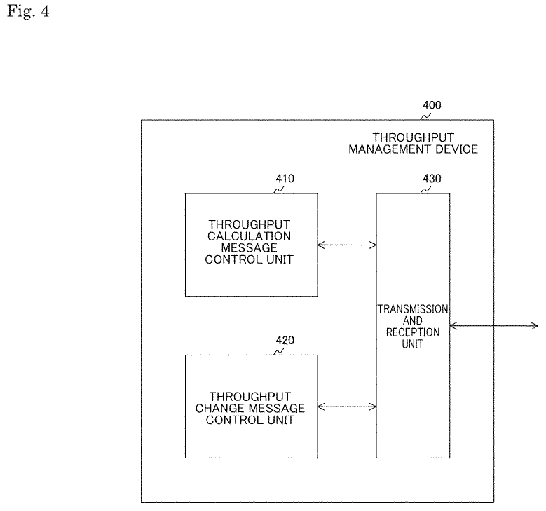

FIG. 4 is a diagram illustrating a configuration example of the throughput management device 400 according to an embodiment of the present technology.

The throughput management device 400 includes a throughput calculation message control unit 410, a throughput change message control unit 420, and a transmission and reception unit 430.

The throughput calculation message control unit 410 performs a control to receive a throughput calculation request message from the terminal 100 and in response to this, transmit a throughput calculation response message. When the throughput calculation message control unit 410 receives the throughput calculation request message from the terminal 102, the throughput calculation message control unit 410 extracts a terminal identifier and a throughput request value, which are stored in the message, and calculates a recommended throughput based on the following equation.

Recommended throughput=min (throughput request value, maximum throughput)

Here, the function min is a function that outputs the minimum value among the arguments.

The maximum throughput is the maximum value of throughput that can be expected in a case where the terminal 102 shares the frequency resources of the terminal 101 and the base station 200. In a case where frequency resources are equally allocated to the terminals 101 and 102, the maximum throughput is, for example, a value calculated by the following equation.

Maximum throughput=(Throughput of one terminal occupying all frequency resource sources)/(Total number of terminals for base station)

Here, Σ the throughput of one terminal occupying all frequency resource sources may be calculated using, for example, the equation described in 3GPP TS 38.306 4.1.2. Specifically, it is as follows:

$$Throughput = {10}^{- 6} \cdot \sum ( {v}^{( j )} \cdot {Q}^{( j )} \cdot {f}^{( j )} \cdot R \cdot ( {N}^{( j ) , μ} \cdot 12 ) / {T}^{μ} ) \cdot ( 1 - {OH}^{( j )} )$$

Here, Σ is a function indicating a sum with j=1 to J. The variable v is the number of layers, Q is the maximum modulation order, f is a scaling factor, R is a constant, N is the maximum number of resource blocks, Tis an OFDM symbol interval, and OH is an overhead determined by the frequency and communication direction. This equation only represents the maximum throughput, and by calculating the respective variables based on the current values of the terminal 100, the throughput of a terminal 100 occupying all frequency resource sources can be obtained.

In order to acquire the values of the variables represented in the above equation, it is necessary to acquire from the base station 200 wireless parameters of the terminal(s) 102 in addition to the number of terminals 101 that are in operation. The wireless parameters may include, for example, bandwidth, the number of layers, and modulation method.

In the base station 200, identifiers different from terminal identifiers are generally used such as International Mobile Subscription Identity (IMSI) and International Mobile Equipment Identity (IMEI) to manage information. Therefore, it is necessary to be able to acquire an identifier (e.g., RAN UE NGAP ID, etc.) that can uniquely identify each terminal 102 in the base station 200 from the AMF and SMF in the core network 300.

If all the terminals 101 that are in operation comply with the throughput change request, the recommended throughput and the initial value of an operation parameter having the same value as the recommended throughput are set in the throughput calculation response message to be transmitted. On the other hand, if one or some of the terminals 101 that are in operation do not comply with the throughput change request, the recommended throughput and the initial value of an operation parameter having a value (e.g., zero [Mbps]) equal to or less than the recommended throughput are set in the throughput calculation response message to be transmitted. Thus, if all the terminals 101 that are in operation comply with the throughput change request, the terminal(s) 102 can start communication with the recommended throughput. If one or some of the terminals 101 that are in operation do not comply with the throughput change request, the terminal(s) 102 start communication initially with a low throughput, thereby preventing an increase in latency in the terminals 101 that are in operation.

The throughput change message control unit 420 performs a control to transmit a throughput change request message requesting to change the throughput to the terminal(s) 101 that are in operation, and in response to this, receive a throughput change response message. This throughput change message control unit 420 calculates a recommended throughput for the terminal(s) 101 that are in operation in the same manner as the throughput calculation message control unit 410.

When the recommended throughput is less than the throughput request value, the throughput change message control unit 420 transmits to the terminal(s) 101 a throughput change instruction message in which the recommended throughput is set. When the throughput change message control unit 420 receives the throughput change response message, the throughput change message control unit 420 notifies the throughput calculation message control unit 410 whether or not the terminal 101 has complied with the throughput change request.

The transmission and reception unit 430 performs transmission and reception to and from the terminal 100 under the control of the throughput calculation message control unit 410 and the throughput change message control unit 420.

### [Message]

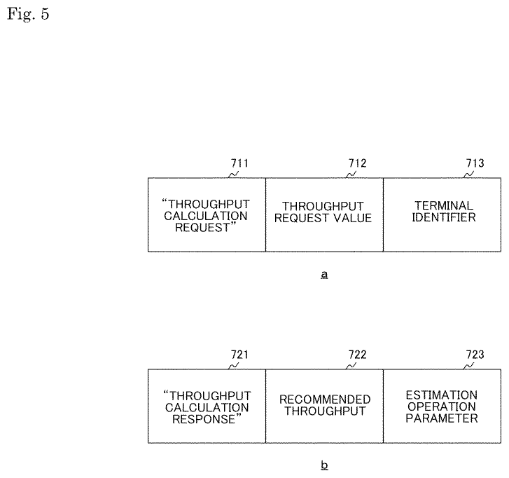

FIG. 5 illustrates an example of field configurations of a throughput calculation request message and a throughput calculation response message according to a first embodiment of the present technology.

In the figure, a is an example of the field configuration of the throughput calculation request message. The throughput calculation request message is a message for the terminal 102 to request the throughput management device 400 to calculate a recommended throughput. This throughput calculation request message includes fields for a message identifier 711, a throughput request value 712, and a terminal identifier 713.

The message identifier 711 is used to identify this message as a throughput calculation request message.

The throughput request value 712 indicates a throughput value (e.g., Mbps) requested by the terminal 102. It is assumed that this throughput request value 712 is given in advance according to the application, but it may be given dynamically from the outside.

The terminal identifier 713 is an identifier for uniquely identifying the terminal 102 in the mobile network 500. As this terminal identifier 713, for example, IMSI or IMEI that can be acquired from the terminal identifier acquisition unit 132 may be used.

In the figure, b is an example of the field configuration of the throughput calculation response message. The throughput calculation response message is a message for the throughput management device 400 to transmit a response to the throughput calculation request message to the terminal 102. This throughput calculation response message includes fields for a message identifier 721, a recommended throughput 722, and an estimation operation parameter 723.

The message identifier 721 is used to identify this message as a throughput calculation response message.

The recommended throughput 722 indicates a recommended throughput (e.g., Mbps) for the terminal 102.

The estimation operation parameter 723 indicates an operation parameter related to the operation of the throughput estimation unit 122. This operation parameter includes, for example, a parameter related to an initial value of the amount of data to be transmitted and a rate of change at which the amount of data is to increase. In this setting, when the recommended throughput and the initial value are the same, the throughput estimation result management unit 123 overwrites the result of the throughput estimation unit 122 so that communication is performed using the specified recommended throughput simultaneously with the start of communication.

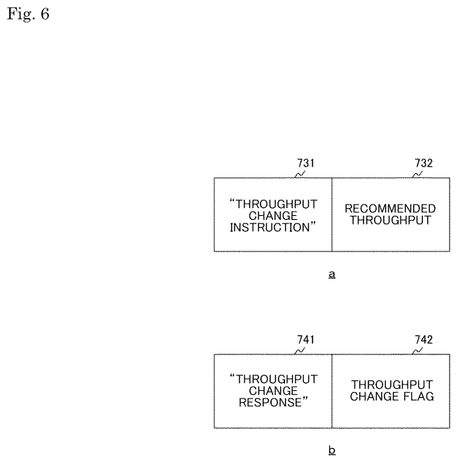

FIG. 6 illustrates an example of field configurations of a throughput change instruction message and a throughput change response message according to the first embodiment of the present technology.

In the figure, a is an example of the field configuration of the throughput change instruction message. The throughput change instruction message is a message for the throughput management device 400 to instruct the terminal 101 to change the throughput. This throughput change instruction message includes fields for a message identifier 731 and a recommended throughput 732.

The message identifier 731 is used to identify this message as a throughput change instruction message.

The recommended throughput 732 indicates a recommended throughput to which the terminal 101 is to change the throughput.

In the figure, b is an example of the field configuration of the throughput change response message. The throughput change response message is a message for the terminal 101 to transmit a response to the throughput change instruction message to the throughput management device 400. This throughput change response message includes fields for a message identifier 741 and a throughput change flag 742.

The message identifier 741 is used to identify this message as a throughput change response message.

The throughput change flag 742 indicates whether or not the terminal 101 has changed the throughput.

### [Operation]

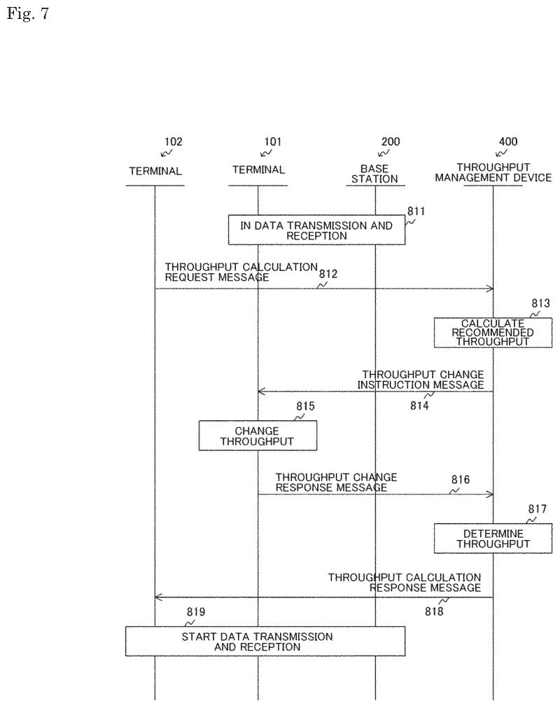

FIG. 7 is a sequence diagram illustrating an example of a processing flow of a wireless communication system according to the first embodiment of the present technology. Although the throughput management device 400 is described here as a separate device from the base station 200, the throughput management device 400 may be physically one device. In other words, the throughput management device 400 may be part of the base station 200.

It is assumed that the terminal 101 connects to the base station 200 to transmit and receive data (811). This is just an example, and the communication does not necessarily have to be with a base station device. For example, the communication may be communication with a relay communication device or side link communication.

The terminal 102 that newly connects to the base station 200 to attempt to start transmitting and receiving data transmits a throughput calculation request message to the throughput management device 400 (812).

When receiving the throughput calculation request message, the throughput management device 400 uses the terminal identifiers of the terminals 101 and 102 to acquire wireless parameters from the base station 200 and the core network 300, and calculates a recommended throughput for each terminal (813).

The throughput management device 400 then transmits a throughput change instruction message to the terminal 101 (814). At this time, the throughput management device 400 may identify the terminal(s) 101 for which the throughput request value exceeds the recommended throughput, and transmit a throughput change instruction message to the corresponding terminal(s). The throughput management device 400 may acquire the throughput request value of the terminal 101 from the terminal 101 in advance, or the base station device 200 or the throughput management device 400 may calculate the throughput request value based on information on the terminal 101.

When receiving the throughput change instruction message, the terminal 101 selects whether or not to reduce the throughput to the recommended throughput. Then, if the terminal 101 selects to reduce the throughput, the terminal 101 changes the throughput to the recommended throughput (815). In either case, the terminal 101 transmits a throughput change response message including the throughput change flag 742 that is the result of selection (816).

When receiving the throughput change response message, the throughput management device 400 determines the throughput change flag 742 indicating whether or not the terminal 101 has changed the throughput (817). This determination may be based on signaling acquired from the terminal 101, or may be calculated by the base station device 200 or the throughput management device 400. Then, a throughput calculation response message is transmitted to the terminal 102 (818).

When receiving the throughput calculation response message, the terminal 102 uses the recommended throughput 722 and/or the estimation operation parameter 723, which are included in the throughput calculation response message, to start transmitting and receiving data (819).

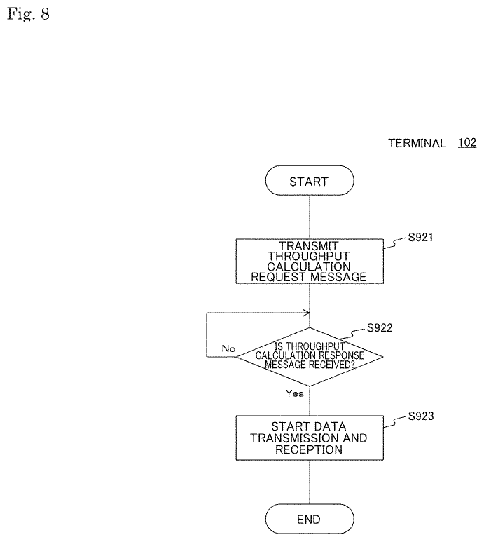

FIG. 8 is a flowchart illustrating an example of a processing procedure of the terminal 102 according to the first embodiment of the present technology.

The terminal 102 that attempts to start transmitting and receiving data transmits a throughput calculation request message including the throughput request value 712 and the terminal identifier 713 to the throughput management device 400 (step S921).

Then, when the terminal 102 receives the throughput calculation response message from the throughput management device 400 (step S922: Yes), the terminal 102 uses the recommended throughput 722 and the estimation operation parameter 723, which are included in the throughput calculation response message, to start transmitting and receiving data (step S923).

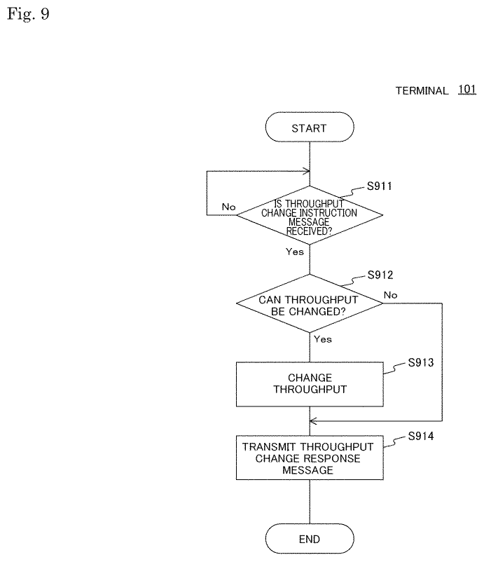

FIG. 9 is a flowchart illustrating an example of a processing procedure of the terminal 101 according to the first embodiment of the present technology.

When the terminal 101 that is transmitting and receiving data receives the throughput change instruction message from the throughput management device 400 (step S911: Yes), the terminal 101 determines whether or not to reduce the throughput to the recommended throughput 732, which is included in the throughput change instruction message (step S912).

When the terminal 101 determines to reduce the throughput (step S912: Yes), the terminal 101 reduces the throughput to the recommended throughput 732 (step S913). In either case, the terminal 101 transmits a throughput change response message including the throughput change flag 742 to the throughput management device 400 (step S914).

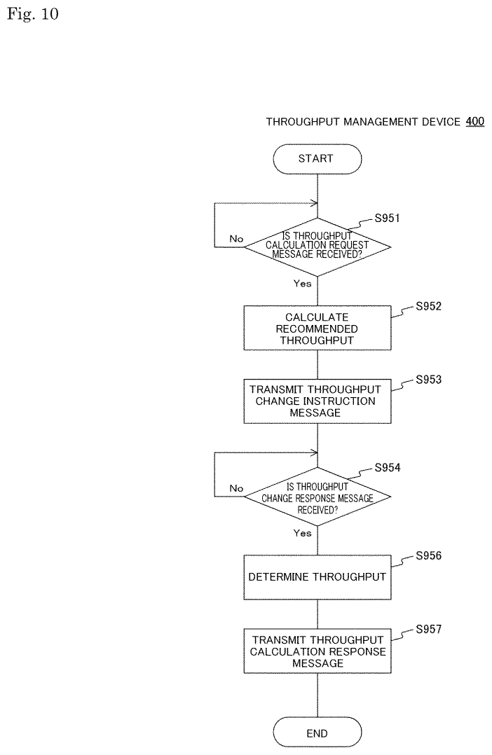

FIG. 10 is a flowchart illustrating an example of a processing procedure of the throughput management device 400 according to the first embodiment of the present technology.

When the throughput management device 400 receives the throughput calculation request message (step S951: Yes), the throughput management device 400 acquires wireless parameters from the base station 200 and the core network 300 and calculates a recommended throughput (step S952). Then, a throughput change instruction message including the recommended throughput 732 is transmitted to the terminal 101 (step S953).

After that, when the throughput management device 400 receives the throughput change response message from the terminal 101 (step S954: Yes), the throughput management device 400 determines the throughput change flag 742 indicating whether or not the terminal 101 has changed the throughput (step S956). Then, a throughput calculation response message is transmitted to the terminal 102 (step S957).

As described above, in the first embodiment of the present technology, the throughput of the terminal 101 that is in operation from the terminal 102 via the throughput management device 400 is reduced in advance. Thus, even when the terminal 102 operates at a high throughput at the start of data transmission and reception, it is possible to avoid an unintended increase in latency in the terminal 101 that is in operation.

That is, the terminal 102 starting communication at a desired throughput may cause the maximum throughput of the terminal 101 that is in operation to be reduced. In addition, when the throughput at the terminal 101 falls below the originally required throughput, an increase in latency due to queuing will occur unless the terminal 101 suppresses the throughput. Therefore, in the first embodiment, in order to prevent an increase in latency in the terminal 101, after the terminal 101 reduces the throughput, the terminal 102 starts communication at the desired throughput.

### 2. Second Embodiment

In the first embodiment described above, the throughput management device 400 calculates a recommended throughput for the terminal 101 using a throughput calculation request message as a trigger from the terminal 102, and notifies the terminal 101 of the result. The terminal 101 determines whether or not to reduce the throughput to the recommended throughput, and notifies the throughput management device 400 of the result using a throughput change response message. The throughput management device 400 determines the recommended throughput and operation parameters for the terminal 102 based on the throughput change response messages from all the terminals 101, and notifies the terminal 102 using a throughput calculation response message. In this case, the throughput management device 400 needs to wait until it receives a throughput change response messages from each terminal 101, and depending on, for example, the number of terminals 101, it takes time to notify the terminal 102 of the recommended throughput.

Therefore, in a second embodiment, by managing the range in which each terminal 101 changes the throughput, the throughput management device 400 can transmit a throughput calculation response message to the terminal 102 without receiving a throughput change response message from each terminal 101.

The basic configuration of a wireless communication system according to the second embodiment is the same as that in the first embodiment described above, and thus, detailed description thereof will be omitted.

### [Message]

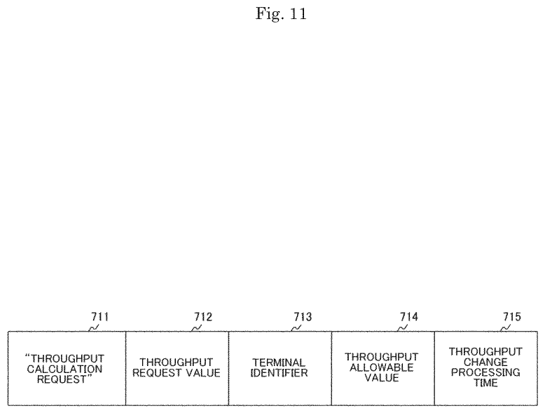

FIG. 11 illustrates an example of a field configuration of a throughput calculation request message according to the second embodiment of the present technology. In the second embodiment, the throughput change response message is not used. In addition, the throughput change instruction message and the throughput change response message are the same as those in the first embodiment described above, and thus, detailed description thereof will be omitted.

The throughput calculation request message according to the second embodiment includes fields for a throughput allowable value 714 and a throughput change processing time 715 in addition to the message identifier 711, the throughput request value 712, and the terminal identifier 713.

The throughput allowable value 714 indicates a throughput value (e.g., Mbps) that is allowable for the terminal 102. If the calculated recommended throughput is below the throughput allowable value 714, the throughput management device 400 stores the throughput allowable value 714 in the recommended throughput 732 of the throughput change instruction message. On the other hand, if the calculated recommended throughput exceeds the throughput allowable value 714, the throughput management device 400 stores the calculated recommended throughput in the recommended throughput 732 of the throughput change instruction message.

The throughput change processing time 715 indicates the upper limit value (e.g., milliseconds) of the time required to change the throughput in the terminal 101. When the throughput change processing time 715 has elapsed since all throughput change instruction messages were transmitted, the throughput management device 400 sets the throughput change flag 742 to indicate whether or not there is a terminal 101 for which the recommended throughput is below the throughput allowable value 714, and transmits the resulting throughput change response message.

### [Operation]

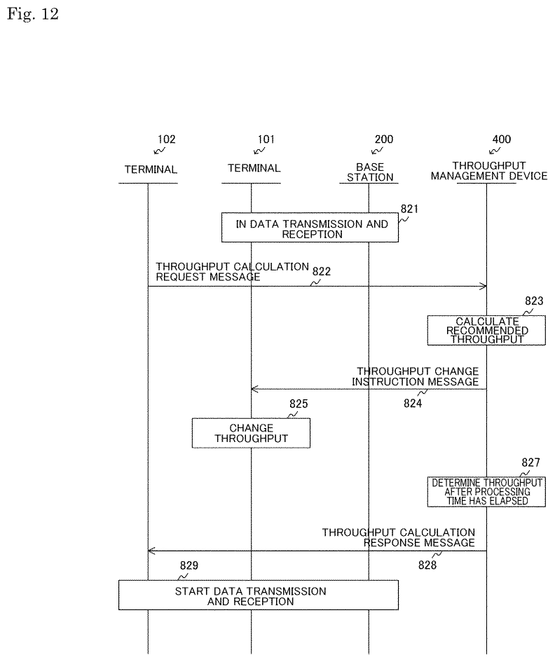

FIG. 12 is a sequence diagram illustrating an example of a processing flow of the wireless communication system according to the second embodiment of the present technology. Although the throughput management device 400 is described here as a separate device from the base station 200, the throughput management device 400 may be physically one device. In other words, the throughput management device 400 may be part of the base station 200.

It is assumed that the terminal 101 connects to the base station 200 to transmit and receive data (821). This is just an example, and the communication does not necessarily have to be with a base station device. For example, the communication may be communication with a relay communication device or side link communication.

The terminal 102 that newly connects to the base station 200 to attempt to start transmitting and receiving data transmits a throughput calculation request message to the throughput management device 400 (822). This throughput calculation request message further includes fields for the throughput allowable value 714 and the throughput change processing time 715, as compared to the first embodiment described above.

When receiving the throughput calculation request message, the throughput management device 400 uses the terminal identifiers of the terminals 101 and 102 to acquire wireless parameters from the base station 200 and the core network 300, and calculates a recommended throughput (823).

If the calculated recommended throughput is below the throughput allowable value 714, the throughput management device 400 stores the throughput allowable value 714 in the recommended throughput 732 of the throughput change instruction message. On the other hand, if the calculated recommended throughput exceeds the throughput allowable value 714, the throughput management device 400 stores the calculated recommended throughput in the recommended throughput 732 of the throughput change instruction message. The throughput management device 400 then transmits the throughput change instruction message to the terminal 101 (824).

When receiving the throughput change instruction message, the terminal 101 selects whether or not to reduce the throughput to the recommended throughput. Then, if the terminal 101 selects to reduce the throughput, the terminal 101 changes the throughput to the recommended throughput (825). However, unlike the first embodiment described above, a throughput change response message is not transmitted.

When the throughput change processing time 715 of the throughput calculation request message has elapsed, the throughput management device 400 determines the throughput change flag 742 indicating whether or not the terminal 101 has changed the throughput (827). Then, a throughput calculation response message is transmitted to the terminal 102 (828).

When receiving the throughput calculation response message, the terminal 102 uses the recommended throughput 722 and the estimation operation parameter 723, which are included in the throughput calculation response message, to start transmitting and receiving data (829).

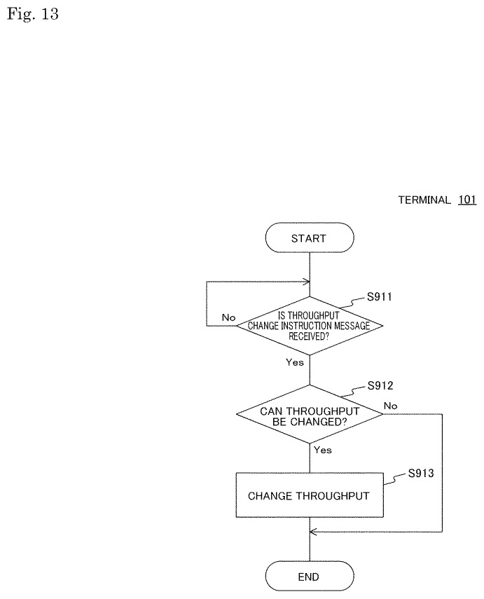

FIG. 13 is a flowchart illustrating an example of a processing procedure of the terminal 101 according to the second embodiment of the present technology.

When the terminal 101 that is transmitting and receiving data receives the throughput change instruction message from the throughput management device 400 (step S911: Yes), the terminal 101 determines whether or not to reduce the throughput to the recommended throughput 732, which is included in the throughput change instruction message (step S912). If the terminal 101 determines to reduce the throughput (step S912: Yes), the terminal 101 reduces the throughput to the recommended throughput 732 (step S913).

The operation up to this point is the same as that of the first embodiment described above. However, in the second embodiment, the terminal 101 does not transmit a throughput change response message to the throughput management device 400.

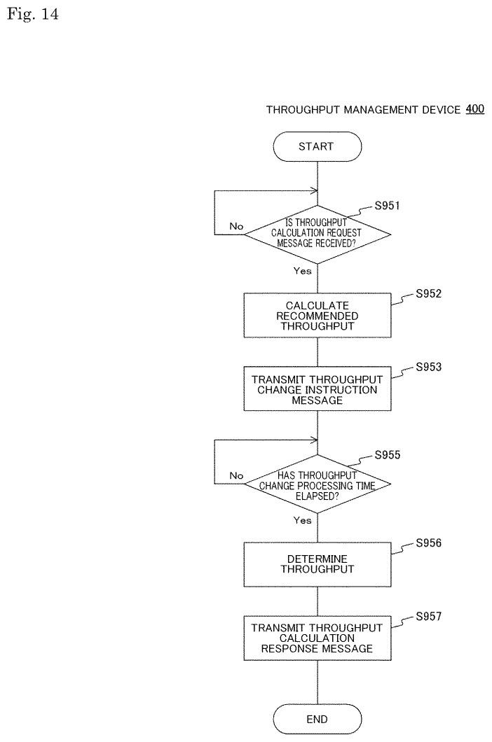

FIG. 14 is a flowchart illustrating an example of a processing procedure of the throughput management device 400 according to the second embodiment of the present technology.

When the throughput management device 400 receives the throughput calculation request message (step S951: Yes), the throughput management device 400 acquires wireless parameters from the base station 200 and the core network 300 and calculates a recommended throughput (step S952). Then, a throughput change instruction message including the recommended throughput 732 is transmitted to the terminal 101 (step S953).

The operation up to this point is the same as that of the first embodiment described above. However, in the second embodiment, when the throughput change processing time 715 of the throughput calculation request message has elapsed (step S955: Yes), the throughput management device 400 determines the throughput change flag 742 indicating whether or not the terminal 101 has changed the throughput without waiting for a throughput change response message (step S956). Then, a throughput calculation response message is transmitted to the terminal 102 (step S957).

In this way, in the second embodiment of the present technology, when the throughput change processing time 715 has elapsed since the throughput change instruction message was transmitted, a throughput calculation response message is promptly transmitted to the terminal 102. As a result, the time required to notify the terminal 102 of the recommended throughput can be shortened without waiting for a throughput change response message as in the first embodiment, and the terminal 102 can start transmitting and receiving data early.

### 3. Third Embodiment

In the second embodiment described above, the throughput management device 400 determines a recommended throughput for the terminal 101 using information regarding the throughput allowable value of the terminal 101, and transmits a throughput change request message. However, when a plurality of terminals 101 present the same throughput allowable value, it is not possible to prioritize the recommended throughputs among the terminals 101.

Therefore, in a third embodiment, the throughput management device 400 receives, in addition to the range in which the terminal 101 changes the throughput, a value representing the quality of experience obtained within the range. Thus, when calculating recommended throughputs for the terminals 101 and 102, the throughput management device 400 ensures that their QoEs are at least a certain level or higher.

The basic configuration of a wireless communication system according to the third embodiment is the same as that in the first embodiment described above, and thus, detailed description thereof will be omitted.

### [Message]

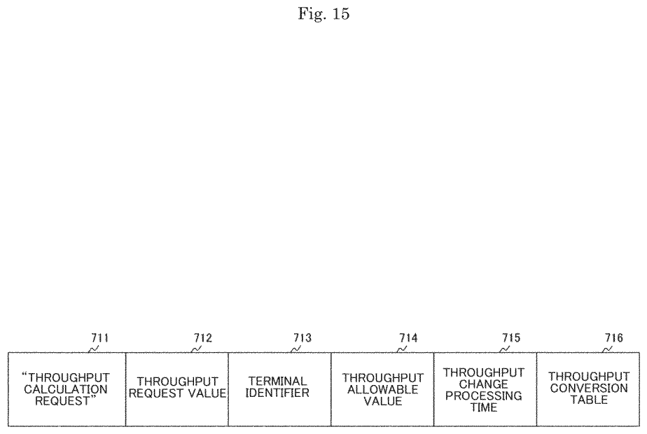

FIG. 15 illustrates an example of a field configuration of a throughput calculation request message according to the third embodiment of the present technology. In the third embodiment, the throughput change response message is not used. In addition, the throughput change instruction message and the throughput change response message are the same as those in the first embodiment described above, and thus, detailed description thereof will be omitted.

The throughput calculation request message according to the third embodiment includes fields for a throughput conversion table 716 in addition to the message identifier 711, the throughput request value 712, the terminal identifier 713, the throughput allowable value 714, and the throughput change processing time 715.

The throughput conversion table 716 is a table indicating a correspondence between throughput and quality of experience (QoE) obtained in that throughput.

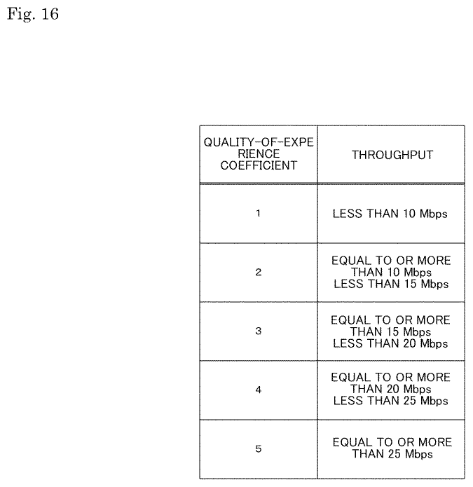

FIG. 16 illustrates an example of a field configuration of the throughput conversion table 716 according to the third embodiment of the present technology.

This throughput conversion table 716 indicates a correspondence between quality of experience coefficient and throughput. It can be seen that as the throughput increases, the quality-of-experience (QoE) coefficient increases.

Here, as an example of quality of experience coefficient, an example of five-level evaluation based on the absolute category rating (ACR) is given. In this case, level 3 or more is desirable. Since the sensitivity to the deterioration of the quality of experience due to a decrease in throughput differs depending on the application, the contents of the throughput conversion table 716 can be changed as appropriate.

When calculating recommended throughputs for the terminals 101 and 102, the throughput management device 400 sets as the recommended throughput 722 the smallest throughput value for which the experience value is 3 or more based on the throughput conversion table 716, and transmits the resulting throughput calculation response message.

The basic operation is the same as that of the second embodiment described above, and thus, detailed description of the operation will be omitted.

As described above, according to the third embodiment of the present technology, by transmitting a throughput calculation request message including the throughput conversion table 716 from the terminal 102, the throughput management device 400 can select a throughput in consideration of the quality of experience (QoE). In other words, even when a plurality of terminals 101 present the same throughput allowable value, it is possible to prioritize the recommended throughputs among the terminals 101.

The embodiments described above present examples for embodying the present technology and matters in the embodiments and matters specifying the invention in the claims have a correspondence to each other. Similarly, the matters specifying the invention in the claims and the matters in the embodiments of the present technology having the same name have a corresponding relationship with each other. However, the present technology is not limited to the embodiments and can be embodied by applying various modifications to the embodiments without departing from the scope and spirit thereof.

Further, the processing procedures described in the embodiments described above may be construed as a method having such a series of procedures or may be construed as a program for causing a computer to execute the series of procedures or a recording medium storing the program. Examples of such a recording medium to be used include a compact disc (CD), a MiniDisc (MD), a digital versatile disc (DVD), a memory card, and a Blu-ray disc (Blu-ray (registered trademark) Disc).

The effects described in the present specification are merely examples and are not intended as limiting, and other effects may be obtained.

The present technology can also have the following configurations.

(1) A terminal device transmitting a throughput calculation request message requesting throughput calculation for data transmission and reception through wireless communication, and, in response to receiving a throughput calculation response message, which is a response to the throughput calculation request message, starting the data transmission and reception according to a recommended throughput included in the throughput calculation response message.

(2) The terminal device according to (1), wherein the throughput calculation request message includes a throughput request value for the data transmission and reception, and is a message requesting to reduce a throughput to another terminal device that is performing wireless communication to achieve the throughput request value.

(3) The terminal device according to (1) or (2), wherein the throughput calculation response message includes an initial value of an amount of data subjected to the data transmission and reception and an operation parameter regarding an increase in the amount of data.

(4) A terminal device, in response to receiving a throughput change instruction message instructing to change a throughput of wireless communication, which is being performed, to a recommended throughput, determining whether or not the throughput can be changed to the recommended throughput; and changing the throughput of wireless communication, which is being performed, according to the recommended throughput when the throughput can be changed to the recommended throughput.

(5) The terminal device according to (4), transmitting a throughput change response message, which is a response to the throughput change instruction message, the throughput change response message including a result of determining whether or not the throughput can be changed to the recommended throughput.

(6) The terminal device according to (4) or (5), wherein the determination as to whether or not the throughput can be changed to the recommended throughput is based on whether or not a predetermined quality of experience is satisfied.

(7) A wireless communication system including: a first terminal device that is performing wireless communication; a second terminal device that attempts to perform data transmission and reception through wireless communication; and a throughput management device that manages throughputs of the first terminal device and the second terminal device,
wherein the second terminal device transmits a throughput calculation request message requesting throughput calculation for data transmission and reception through wireless communication,
the throughput management device calculates a recommended throughput for the second terminal device in response to receiving the throughput calculation request message, and transmits a throughput change instruction message instructing to change a throughput of wireless communication, which is being performed at the first terminal device, to the recommended throughput, the first terminal device determines whether or not the throughput can be changed to the recommended throughput in response to receiving the throughput change instruction message, and when the throughput can be changed to the recommended throughput, changes the throughput of wireless communication being performed according to the recommended throughput,
the throughput management device transmits a throughput calculation response message including the recommended throughput, and
the second terminal device starts the data transmission and reception according to the recommended throughput included in the throughput calculation response message in response to receiving the throughput calculation response message.

(8) The wireless communication system according to (7), wherein the throughput management device transmits the throughput calculation response message after receiving from the first terminal device a throughput change response message that is a response to the throughput change instruction message.

(9) The wireless communication system according to (7), wherein the throughput management device transmits the throughput calculation response message after a predetermined time has elapsed since the throughput change instruction message was transmitted.

(10) A method for processing a terminal device, including the steps of: transmitting a throughput calculation request message requesting throughput calculation for data transmission and reception through wireless communication; and
in response to receiving a throughput calculation response message, which is a response to the throughput calculation request message, starting the data transmission and reception according to a recommended throughput included in the throughput calculation response message.

(11) A method for processing a terminal device, including the steps of: receiving a throughput change instruction message instructing to change a throughput of wireless communication, which is being performed, to a recommended throughput;
determining whether or not the throughput can be changed to the recommended throughput; and
changing the throughput of wireless communication, which is being performed according to the recommended throughput, when the throughput can be changed to the recommended throughput.

(12)

A terminal device that starts transmitting and receiving data through wireless communication with a wireless communication device, the terminal device transmitting a throughput calculation request message requesting throughput calculation for the data transmission and reception through the wireless communication to the wireless communication device;
receiving from the wireless communication device a throughput calculation response message that is a response to the throughput calculation request message; and
starting the data transmission and reception according to a recommended throughput included in the throughput calculation response message.

(13)

The terminal device according to (12), wherein the throughput calculation request message is a message requesting to reduce a throughput of another terminal device that is performing wireless communication with the wireless communication device to achieve the throughput request value.

(14)

The terminal device according to (12), wherein the throughput calculation request message is a message requesting to reduce a throughput of another terminal device that is performing wireless communication with the wireless communication device before the terminal device starts data transmission and reception.

### REFERENCE SIGNS LIST

100 to 102 Terminal, Terminal device
110 Application unit
111 Camera
112 Encoding unit
113 Encoding rate changing unit
120 Transport unit
121 Packetization unit
122 Throughput estimation unit
123 Throughput estimation result management unit
130 Wireless communication unit
131 Communication processing unit
132 Terminal identifier acquisition unit
200 Base station
300 Core network
400 Throughput management device
410 Throughput calculation message control unit
420 Throughput change message control unit
430 Transmission and reception unit
500 Mobile network
600 Application server
610 Application unit
611 Display unit
612 Decoding unit
620 Transport unit
621 Depacketization unit
622 Throughput estimation unit
630 Communication unit
631 Communication processing unit

1. A terminal device transmitting a throughput calculation request message requesting throughput calculation for data transmission and reception through wireless communication, and, in response to receiving a throughput calculation response message, which is a response to the throughput calculation request message, starting the data transmission and reception according to a recommended throughput included in the throughput calculation response message.

2. The terminal device according to claim 1, wherein the throughput calculation request message includes a throughput request value for the data transmission and reception, and is a message requesting to reduce a throughput to another terminal device that is performing wireless communication to achieve the throughput request value.

3. The terminal device according to claim 1, wherein the throughput calculation request message is a message requesting to reduce a throughput of another terminal device that is performing wireless communication with the wireless communication device before the terminal device starts data transmission and reception.

4. The terminal device according to claim 1, wherein the throughput calculation response message includes an initial value of an amount of data subjected to the data transmission and reception and an operation parameter regarding an increase in the amount of data.

5. A terminal device, in response to receiving a throughput change instruction message instructing to change a throughput of wireless communication, which is being performed, to a recommended throughput, determining whether or not the throughput can be changed to the recommended throughput, and changing the throughput of wireless communication, which is being performed, according to the recommended throughput when the throughput can be changed to the recommended throughput.

6. The terminal device according to claim 5, transmitting a throughput change response message, which is a response to the throughput change instruction message, the throughput change response message including a result of determining whether or not the throughput can be changed to the recommended throughput.

7. The terminal device according to claim 5, wherein the determination as to whether or not the throughput can be changed to the recommended throughput is based on whether or not a predetermined quality of experience is satisfied.

8. A wireless communication system comprising: a first terminal device that is performing wireless communication; a second terminal device that attempts to perform data transmission and reception through wireless communication; and a throughput management device that manages throughputs of the first terminal device and the second terminal device,
wherein the second terminal device transmits a throughput calculation request message requesting throughput calculation for data transmission and reception through wireless communication,
the throughput management device calculates a recommended throughput for the second terminal device in response to receiving the throughput calculation request message, and transmits a throughput change instruction message instructing to change a throughput of wireless communication, which is being performed at the first terminal device, to the recommended throughput,
the first terminal device determines whether or not the throughput can be changed to the recommended throughput in response to receiving the throughput change instruction message, and when the throughput can be changed to the recommended throughput, changes the throughput of wireless communication being performed according to the recommended throughput,
the throughput management device transmits a throughput calculation response message including the recommended throughput, and
the second terminal device starts the data transmission and reception according to the recommended throughput included in the throughput calculation response message in response to receiving the throughput calculation response message.

9. The wireless communication system according to claim 8, wherein the throughput management device transmits the throughput calculation response message after receiving from the first terminal device a throughput change response message that is a response to the throughput change instruction message.

10. The wireless communication system according to claim 8, wherein the throughput management device transmits the throughput calculation response message after a predetermined time has elapsed since the throughput change instruction message was transmitted.

11. A method for processing a terminal device, comprising the steps of:
transmitting a throughput calculation request message requesting throughput calculation for data transmission and reception through wireless communication; and
in response to receiving a throughput calculation response message, which is a response to the throughput calculation request message, starting the data transmission and reception according to a recommended throughput included in the throughput calculation response message.

12. A method for processing a terminal device, comprising the steps of:
receiving a throughput change instruction message instructing to change a throughput of wireless communication, which is being performed, to a recommended throughput;
determining whether or not the throughput can be changed to the recommended throughput; and
changing the throughput of wireless communication, which is being performed according to the recommended throughput, when the throughput can be changed to the recommended throughput.
